(19) United States
(12) Patent Application Publication
(10) Pub. No.: US 2010/0157896 A1
(43) Pub. Date: Jun. 24, 2010

(54) METHOD FOR GENERATING FRAME AND TRANSMITTING FRAME INFORMATION

(75) Inventors: Ki Seok KIM, Gyeongju-si (KR); Young-il Kim, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/615,486

(22) Filed: Nov. 10, 2009

(30) Foreign Application Priority Data
Dec. 19, 2008 (KR) 10-2008-0130646

(51) Int. Cl. H04W 40/00; H04J 3/24

(52) U.S. Cl. 370/328; 370/474

(57) ABSTRACT

The present invention relates to a frame generation and transmission method of a wireless communication system. The frame generation method includes dividing a frame into a plurality of subframes, allocating the respective subframes as one of a plurality of predefined modes, and allocating mode allocation information of the respective subframes to the frame information.

### CROSS-REFERENCE TO RELATED APPLICATION

This application claims priority to and the benefit of Korean Patent Application No. 10-2008-0130646 filed in the Korean Intellectual Property Office on Dec. 19, 2008, the entire contents of which are incorporated herein by reference.

### BACKGROUND OF THE INVENTION

(a) Field of the Invention

The present invention relates to a frame generation method and a frame information transmission method in a wireless communication system.

(b) Description of the Related Art

In a wireless communication system, a base station provides broadcasting information to a mobile station. Generally, when the time division duplexing (TDD) scheme is used in the orthogonal frequency division multiplexing (OFDM) system, a frame is divided into a downlink and an uplink. Regarding frame configuration information, the base station provides the number of OFDM symbols of the downlink and the uplink to the mobile station through a system parameter so that the mobile station may detect the frame configuration.

In the case of dividing a frame into a plurality of subframes, information on functions of respective subframes and the number of allocation symbols must be provided through the system parameter. However, when the information on the functions of all the subframes and the number of allocation symbols is provided, the number of information bits required for providing frame information is excessively increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to predefine functions of subframes and providing frame allocation information that is broadcasting information of the OFDM-based wireless communication system, thereby minimizing the number of allocation information bits.

An exemplary embodiment of the present invention provides a method for generating a frame of a wireless communication system, including: dividing a frame into a plurality of subframes; allocating the respective subframes as one of a plurality of predefined modes; and allocating mode allocation information of the respective subframes to the frame information.

The mode allocation information has N bits, each mode corresponds to one of data expressed with the N bits, and N is a natural number.

Part of the plurality of modes support the relay link section, and other partial modes support the access link section.

Part of the plurality of modes support the uplink section, and other partial modes support the downlink section.

The plurality of modes follows at least one communication standard.

Part of the plurality of modes support combination of one of a plurality of communication standards, one of a plurality of communication link sections, and one of an uplink section and a downlink section, and the plurality of communication link sections include a relay link section and an access link section.

The method further includes allocating the mode allocation information to a broadcasting channel of the frame.

Another embodiment of the present invention provides a method for transmitting frame information of a wireless communication system, including: dividing a frame into a plurality of subframes; allocating the respective subframes as one of a plurality of predefined modes; allocating mode allocation information of the respective subframes to frame information; and broadcasting the frame information.

Part of the plurality of modes respectively support one of the access uplink, the access downlink, the relay uplink section, and the relay downlink section.

According to an embodiment of the present invention, frame allocation information configured with subframes can be minimized in the orthogonal frequency division multiplexing system for providing frame information.

### BRIEF DESCRIPTION OF THE DRAWINGS

FIG. 1 shows a block diagram of a wireless communication system according to an exemplary embodiment of the present invention.

FIG. 2 shows a configuration of a frame having eight subframes in the 802.16m system.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation, and can be implemented by hardware components or software components and combinations thereof.

In the specification, a mobile station (MS) may indicate a terminal, a mobile terminal (MT), a subscriber station (SS), a portable subscriber station (PSS), user equipment (UE), and an access terminal (AT), and it may include entire or partial functions of the terminal, the mobile terminal, the subscriber station, the portable subscriber station, the user equipment, and the access terminal.

In the specification, a base station (BS) may indicate an access point (AP), a radio access station (RAS), a nodeB (Node-B), an evolved Node-B (eNB), a base transceiver station (BTS), and a mobile multihop relay (MMR)-BS, and it may include entire or partial functions of the access point, the radio access station, the nodeB, the evolved Node-B, the base transceiver station, and the mobile multihop relay-BS.

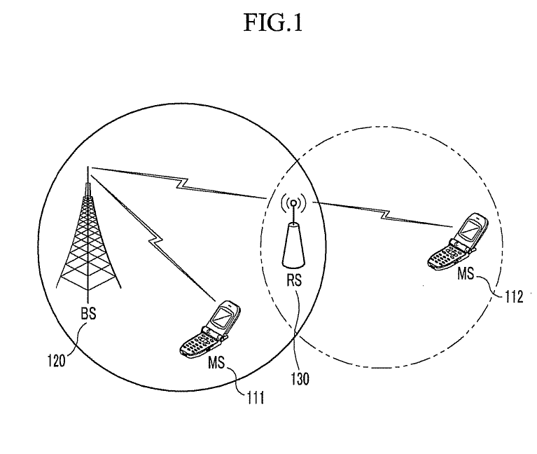

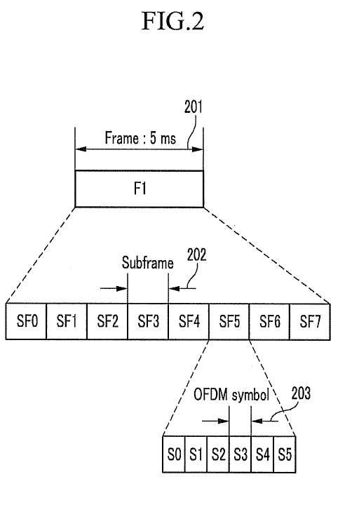

A frame generation method of wireless communication broadcasting information according to an exemplary embodiment of the present invention will now be described with reference to FIG. 1 and FIG. 2.

FIG. 1 shows a block diagram of a wireless communication system according to an exemplary embodiment of the present invention, and FIG. 2 shows a configuration of a frame having eight subframes in the 802.16m system.

Referring to FIG. 1, a communication network of a wireless communication system includes a first mobile station (MS) 111 and a base station (BS) 120, and may further include a relay station (RS) 130 and a second mobile station 112.

Depending on the cases, the communication network can support a multiple RS for multi hops, and the embodiment of the present invention exemplifies the 2-hop system including a relay station 130 as shown in FIG. 1.

The first and second mobile stations 111 and 112 access the base station 120 and transmit/receive high-speed packet data to/from the endpoint of a radio channel by using the transmitting/receiving function following the radio access standard of a wireless communication system, for example, a portable Internet system, and the media access control (MAC) process function.

The first mobile station 111 is provided in the coverage of the base station 120 and directly communicates with the base station 120. The second mobile station 112 communicates with the base station 120 via a relay station 130.

The base station 120 receives radio signals from the mobile station 110 and transmits them to a control station (not shown) or converts the data transmitted by the control station into radio signals and transmits them to the first mobile station 111, and it performs an initial access to the first mobile station 111, an inter-sector handover control function, and a quality of service (QoS) control function.

The relay station 130 is introduced so as to extend the coverage of the base station, the relay station 130 and the base station 120 directly communicate with each other, and the second mobile station 112 in the relay station area indirectly communicates with the base station 120 via the relay station 130.

Referring to FIG. 2, one frame 201 of the wireless communication system includes a plurality of subframes 202.

One frame 201 may have a length of 5 ms. Also, a plurality of frames (e.g., 4 frames) may configure a superframe.

Each subframe 202 includes a plurality of symbols, for example, OFDM symbols 203, and the number of symbols included in one subframe 202 can be 6. The base station 120 allocates a mode of each subframe as one of a plurality of predetermined modes, and provides mode allocation information of each subframe to the mobile station 110. The base station 120 may transmit frame information including mode allocation information of each subframe to the mobile station 110, and the frame information can be allocated to the broadcasting channel of the frame or the superframe. In this case, since the mode is allocated as one of the plurality of modes to each subframe, allocation information of each subframe can include the number of bits for selecting one of a plurality of modes. For example, when the number of predetermined modes is 8, the base station 120 sets allocation information of each subframe to be 3 bits as shown in Table 1 to provide mode allocation information of each subframe.

TABLE 1

| Field | Length (bits) |
|---|---|
| typedef frame_info { | |
| 1st-subframe: | 3 |
| 2nd-subframe: | 3 |
| 3rd-subframe: | 3 |
| 4th-subframe: | 3 |
| 5th-subframe: | 3 |
| 6th-subframe: | 3 |
| 7th-subframe: | 3 |
| 8th-subframe: | 3 |
| } | |

A plurality of modes to which each subframe will be allocated will now be described in detail with reference to Table 2.

The wireless communication system according to the exemplary embodiment of the present invention can support previous communication standards as well as the present communication standards. For example, when the wireless communication system according to the exemplary embodiment of the present invention follows the Institute of Electrical and Electronics Engineers (IEEE) 802.16m communication standard, the wireless communication system can also support the IEEE 802.16e and/or IEEE 802.16j communication standards. In this case, each subframe can be allocated as one of the mode for supporting the IEEE 802.16m system and the mode for supporting the IEEE 802.16e and/or IEEE 802.16j system.

As described with reference to FIG. 1, when the wireless communication system includes a relay station 130, the communication link section of the wireless communication system may have an access link section for intercommunication between the mobile station 111 and the base station 120, intercommunication between the mobile station 112 and the relay station 130, and a relay link section for intercommunication between the base station 120 and the relay station 130. In this case, each subframe can be allocated as one of the mode for supporting the access link section and the mode for supporting the relay link section.

Further, the wireless communication system may have an uplink and a downlink. In this case, each subframe can be allocated as one of the mode for supporting the uplink and the mode for supporting the downlink.

When the above-noted three cases are applied, mode information of each subframe of the wireless communication system according to the exemplary embodiment of the present invention can support one of the 802.16m communication standard access downlink, the 802.16m communication standard access uplink, the 802.16m communication standard relay downlink, the 802.16m communication standard relay uplink, the 802.16e communication standard access downlink, the 802.16e communication standard access uplink, the 802.16j communication standard relay downlink, and the 802.16j communication standard relay uplink. In this case, as shown in Table 2, it is possible to allocate the data for the 8 modes as 0, 1, 2, 3, 4, 5, 6, and 7 respectively, and the base station 120 can set mode allocation information of each subframe as data of the mode to which the corresponding subframe is allocated from among the data from 0 to 7.

TABLE 2

| Data | Mode |
|---|---|
| 0 | 802.16m access downlink |
| 1 | 802.16m access uplink |
| 2 | 802.16m relay downlink |
| 3 | 802.16m relay uplink |
| 4 | 802.16e access downlink |
| 5 | 802.16e access uplink |
| 6 | 802.16j relay downlink |
| 7 | 802.16j relay uplink |

In the case of supporting the additional mode of Table 3 in addition to the example of Table 2, mode allocation information of each subframe can be 4-bit information.

TABLE 3

| Data | Mode |
|---|---|
| 8 | blank |
| 9 | 802.16e and 802.16m multi-access uplink |
| 10 | multi-hop |
| 11 | ad-hoc |

According to Table 3, a blank mode for supporting the multi-access uplink for the 802.16me terminal and the 802.16e terminal, supporting the multi-hop function, supporting the ad-hoc function, accepting various added functions, supporting mode allocation, and supporting the femto cell can be added as mode allocation information of the subframe of the wireless communication system.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but on the contrary, is intended to cover various modifications and equivalent arrangements included within the spirit and scope of the appended claims.

What is claimed is:

1. A method for generating a frame of a wireless communication system, comprising:
dividing a frame into a plurality of subframes;
allocating the respective subframes as one of a plurality of predefined modes; and
allocating mode allocation information of the respective subframes to the frame information.

2. The method of claim 1, wherein
the mode allocation information has N bits, and
each mode corresponds to one of data expressed with the N bits where N is a natural number.

3. The method of claim 1, wherein
part of the plurality of modes support the relay link section, and other partial modes support the access link section.

4. The method of claim 1, wherein
part of the plurality of modes support the uplink section, and other partial modes support the downlink section.

5. The method of claim 1, wherein
the plurality of modes follow at least one communication standard.

6. The method of claim 1, wherein
part of the plurality of modes support combination of one of a plurality of communication standards, one of a plurality of communication link sections, and one of an uplink section and a downlink section, and
the plurality of communication link sections comprise a relay link section and an access link section.

7. The method of claim 1, further including
allocating the mode allocation information to a broadcasting channel of the frame.

8. A method for transmitting frame information of a wireless communication system, comprising:
dividing a frame into a plurality of subframes;
allocating the respective subframes as one of a plurality of predefined modes;
allocating mode allocation information of the respective subframes to frame information; and
broadcasting the frame information.

9. The method of claim 8, wherein
part of the plurality of modes respectively support one of access uplink, access downlink, a relay uplink section, and a relay downlink section.
